(19) United States
(12) Patent Application Publication
(10) Pub. No.: US 2015/0170554 A1
(43) Pub. Date: Jun. 18, 2015

(54) Force-orienting display system

(71) Applicant: Douglas "Doug" Parker, Casselberry, FL (US)

(72) Inventor: Douglas "Doug" Parker, Casselberry, FL (US)

(73) Assignee: Douglas "Doug" Parker, Casselberry, FL (US)

(21) Appl. No.: 14/568,128

(22) Filed: Dec. 12, 2014

Related U.S. Application Data
(60) Provisional application No. 61/915,466, filed on Dec. 12, 2013.

(51) Int. Cl. G09F 11/02; G09F 7/18; G09F 13/30

(52) U.S. Cl. CPC G09F 11/025; G09F 13/30; G09F 7/18

(57) ABSTRACT

A display system and a method for constructing a dynamic, force-orienting display system aligned by forces, comprising one or more freely rotating, rotational display segments positioned proximally to each other on a rotating or movable surface, displaying one or more properly oriented pictures is disclosed.

### CROSS-REFERENCE TO RELATED APPLICATIONS

This application claims the benefit of provisional patent application for Ser. No. 61/915,466, filed 2013 Dec. 12 by Douglas “Doug” Parker.

### FEDERALLY SPONSORED RESEARCH

Not Applicable

### SEQUENCE LISTING OR PROGRAM

Not Applicable

### BACKGROUND OF THE INVENTION

1. Field of the Invention

The present invention relates generally to card, picture, or sign exhibiting devices that use forces to effect a common alignment of independently rotatable display elements to display one or more pictures.

2. Prior Art

Concrete mixer drums typically sport artwork featuring their company's logos or company names on them for marketing and advertising purposes. That artwork, physically applied to the outside of the drum, is properly displayed and oriented right-side up on one side of the mixing drum, but is upside-down on the opposite side of the drum.

The inverted logo and text, repeatedly employed over the years, has always been an awkward, unspoken, quietly ignored consternation for that industry. Some attempts to work around the restrictions on the mode of display have been to eliminate all recognizable images, trademarks, names, and any text markings from the drum's surface, opting for solid colors or simple graphic designs which have no tops or bottoms. Other approaches have been to place copy on a text baseline located on a circumference of the drum, providing a somewhat readable message. Text on the circumference of the drum was readable and acceptable in that it was never inverted, being readable from both sides, but was used as merely a best case alternative as there was no way to provide for generally horizontally placed text to be displayed right-side up on both sides of the drum.

Any other placement of text on a concrete mixer drum at any orientation other than around its circumference will inevitably appear in an improper orientation, still somewhat readable, but angled and at some point in its rotation, inverted nonetheless.

A preferred solution to the inverted logo dilemma would be simple in design and simple in operation. The concrete hauling vehicles are heavy enough when empty. A solution should add minimal additional weight to the vehicle. The concrete hauling industry is about hauling and pouring concrete, not babysitting a complex and finicky add-on. The industry decision makers probably don't care to spend a lot of time and money on a complicated solution requiring much attention at all. Any solution, though eagerly welcomed, has to be simple, lightweight, and self-sufficient.

Additionally, in an unrelated arena, point-of-purchase and point-of-sale display manufacturers are continually searching for ways to create attractive, interactive, or dynamic displays that are simple in operation and low in cost. Dynamic displays work because they attract people's attention and communicate more information in the same amount of space as a static display. If a way to create a dynamic display on a vertical surface were to be created which would be simple in construction and operation, it would provide yet another tool for the companies that are involved in the design and manufacture of displays for point-of-sale and point-of-purchase displays.

### Objects and Advantages

Accordingly, besides the objects and advantages of the invention described in my above patent, several objects and advantages of the present invention are:

to provide an easily changeable force-orienting display system which provides alignment and display of an image mounted on a receiver substrate on a display segment through the application of existing or applied forces;

to provide an easily changeable, inexpensive, dynamic advertising device for use in point-of-purchase and point-of-sale displays and others; and

to provide an easily changeable, segmented exhibitor display device which through the application of known or applied forces displays multiply sectioned images into their composite images through the employment of a common alignment scheme.

Further objects and advantages of my invention will become apparent from a consideration of the drawings and ensuing process description.

### SUMMARY OF THE INVENTION

The present invention includes a display system and a method of assembling an easily changeable, force-orienting display system when provided with one or more weighted, rotatable display segments positioned proximally to each other mounted to a moving surface. The external surfaces of the multiple display segments have receiver substrate areas determined, and one or more images which are cut into image sections are applied to these receiver substrate areas. As the mounting surface moves, the weighted display segments are acted on by the force of gravity in such a way as to effect a common alignment of each display segment with respect to each other and also with respect to the mounting surface, to dispose common display faces on all display segments in such a manner as to display one or more pictures.

In the drawings, closely related figures have the same number but different alphabetic suffixes.

### DRAWINGS

### Figures

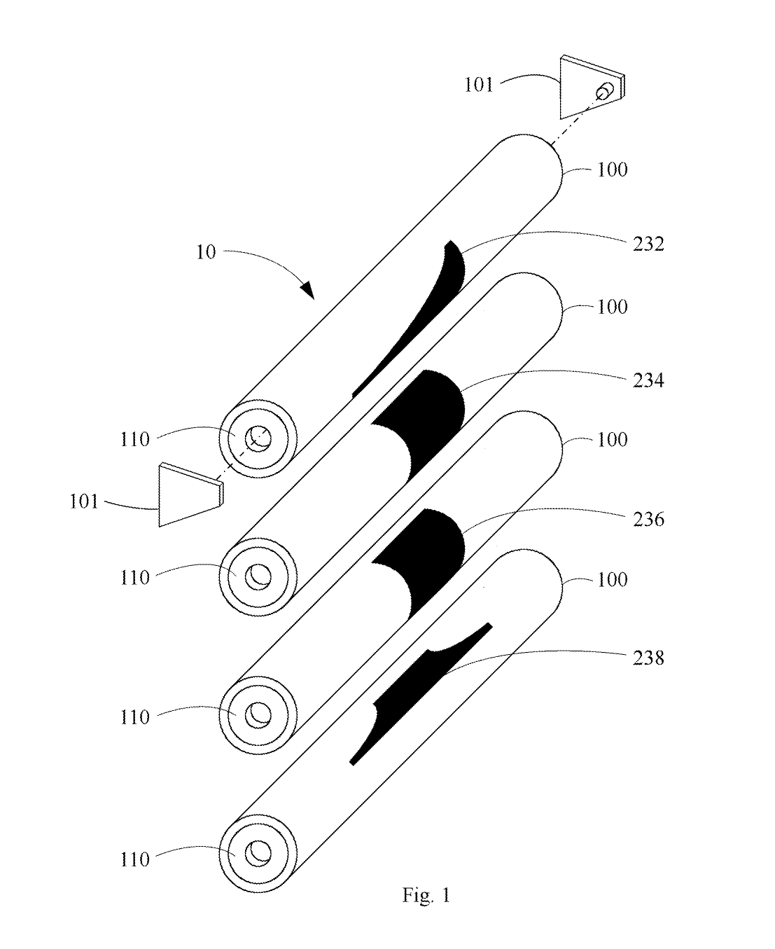

FIG. 1 shows a force-orienting display system comprising four display elements.

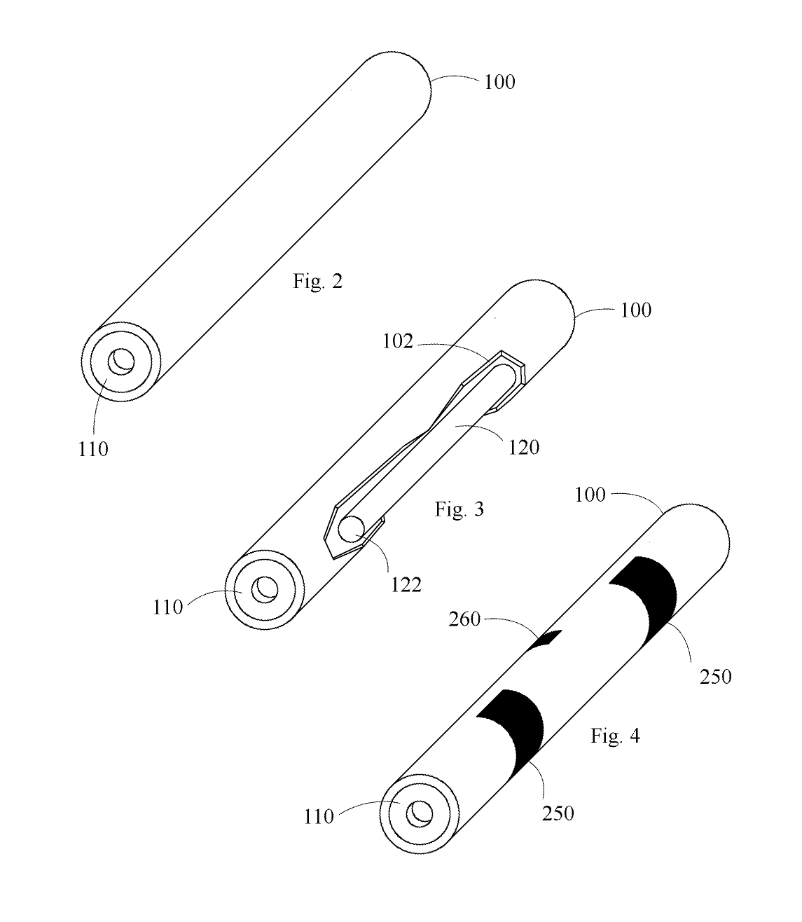

FIG. 2 shows a display element.

FIG. 3 shows a cutaway of a display element illustrating a method of adding a force inducing mass to the inside of a display element.

FIG. 4 shows a display element illustrating how two different graphics are mounted to a left half and a right half of a display element.

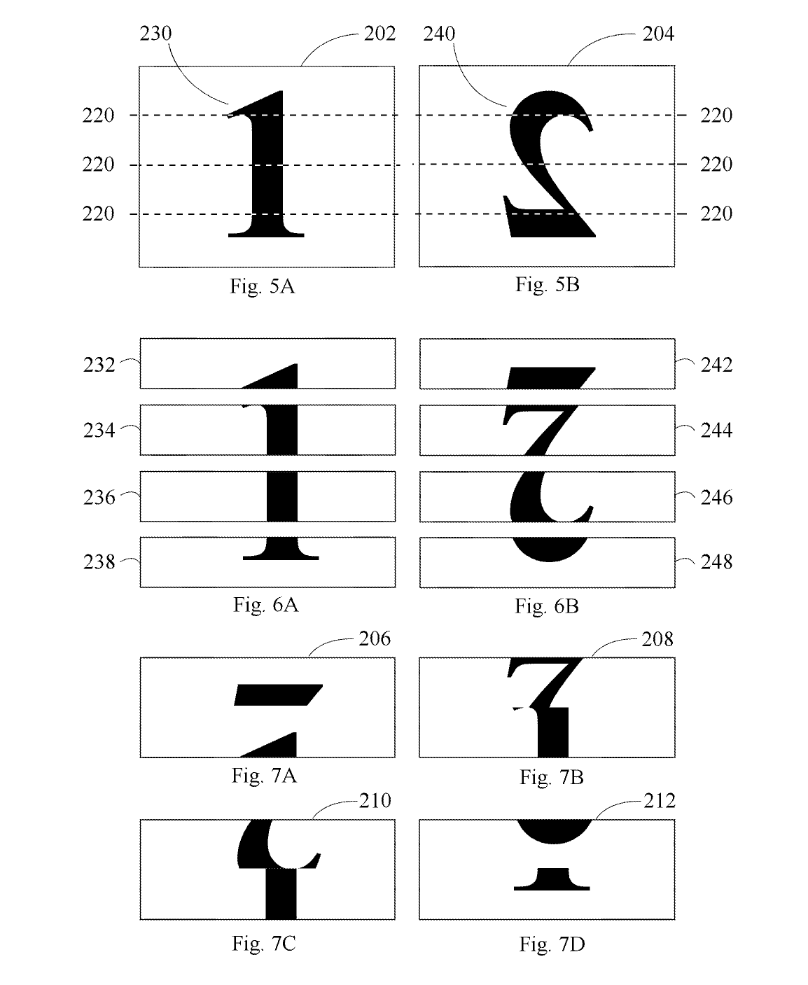

FIG. 5A illustrates a sample picture used in a force-orienting display system and its cut lines.

FIG. 5B illustrates a sample picture used in a force-orienting display system as well as its cut lines. FIG. 5B is reversed, displaying into the page and away from the reviewer.

FIGS. 6A and 6B illustrate how the pictures in FIGS. 5A and 5B are cut into picture sections for mounting.

FIGS. 7A through 7D illustrate how the picture sections of FIGS. 6A and 6B relate to each other when applied to display segments. The figures further illustrate a manner in which their picture sections can be recombined for attachment to display elements.

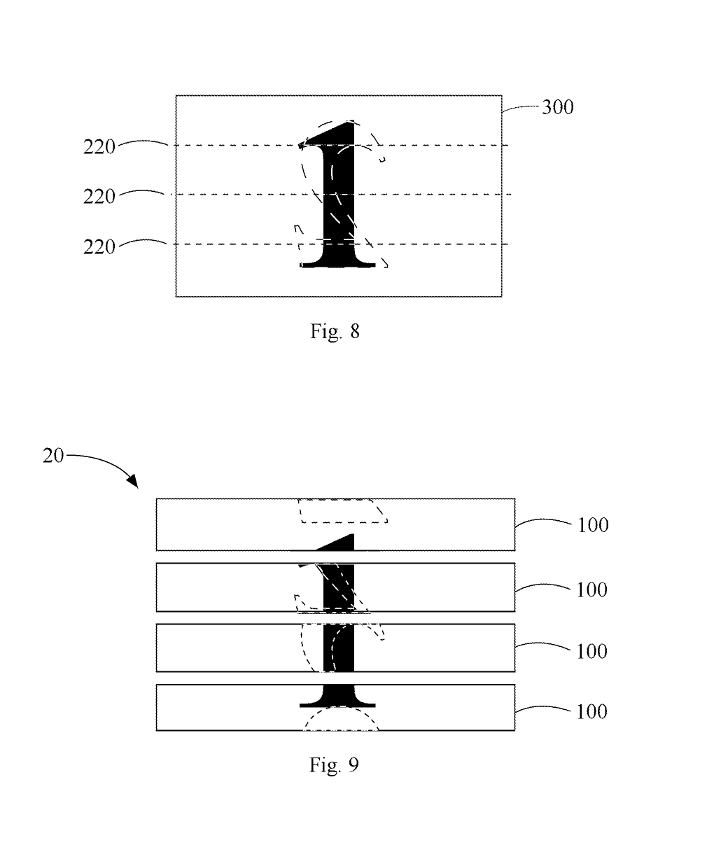

FIG. 8 shows a relative positioning of FIGS. 5A and 5B when stacked back to back.

FIG. 9 illustrates a relative positioning of the picture sections from FIGS. 5A and 5B when applied to display segments of a force-orienting display system.

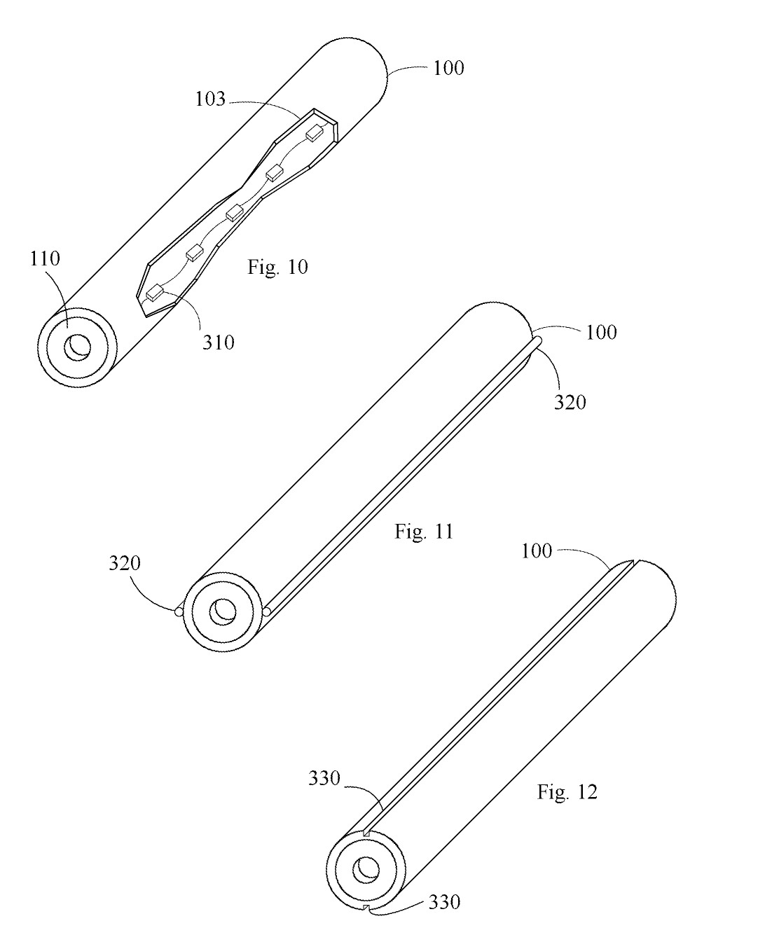

FIG. 10 shows a cutaway view of a display segment with internal lighting devices for internal illumination.

FIG. 11 illustrates a display segment displaying tongues used for slidably mounting removable curved picture section sleds.

FIG. 12 illustrates a display segment with channels used for slidably attaching removable curved picture section sleds.

DRAWINGS - REFERENCE NUMERALS

| | |
|---|---|
| 10 force-orienting display system | 120 force inducing mass |
| 20 force-orienting display system | 122 force inducing mass front face |
| 100 display segment | 202 “1” picture |
| 101 mount | 204 “2” picture |
| 102 display segment cutaway edge | 206 “1” and “2” combined picture |
| 103 display segment cutaway edge | 208 “1” and “2” combined picture |
| 110 rotational mechanism | 210 “1” and “2” combined picture |
| 212 “1” and “2” combined picture | 244 “2” picture section |
| 220 picture cut lines | 246 “2” picture section |
| 230 “1” graphic | 248 “2” picture section |
| 232 “1” picture section | 250 right side graphic section |
| 234 “1” picture section | 260 left side graphic section |
| 236 “1” picture section | 300 relative illustration positioning |
| 238 “1” picture section | 310 internal illumination device |
| 240 “2” graphic (reversed) | 320 tongue |
| 242 “2” picture section | 330 groove |

### DETAILED DESCRIPTION

### FIG. 1—Preferred Embodiment

The following terms will be used throughout the specification and will have the following meanings unless otherwise indicated.

“Picture” refers to a physical image, sign, graphic, or the like.

“Picture section” refers to a subportion of a picture that has been cut into smaller pieces.

“Graphic section” refers to a graphic or a portion of a graphic within a picture.

“Display segment” refers to one of a plurality of elongated display elements with defined receiver substrate areas on its exterior whose receiver substrate areas are used to mount picture sections.

The present invention includes a method of assembling a force-orienting display system. The method includes the steps of providing weighted independently rotatable display segments, mounting the segments on a surface proximally to each other, altering the center of mass of the display segments, defining receiver substrate areas on the exteriors of the segments, selecting pictures to be displayed, cutting the pictures into smaller picture sections, and mounting the picture sections onto the receiver substrate areas. These steps are explained in greater detail in the following detailed description of the preferred embodiment.

In a preferred embodiment a method of assembling a force-orienting display system 10 of the present invention is illustrated in FIG. 1 by providing multiple display segments 100, made from substances such as polymers, plastics, metals, or other materials which may be opaque, semi-transparent, or transparent. In a most preferred embodiment, the display segments are cylinders with circular cross-sections, though any cross section pattern allowing for free rotation of the display segments can be provided. The display segments may be solid or hollow. The display segments comprise one or two rotational mechanism, such as a conventional bearing 110, at one or both ends, allowing for smooth, unobstructed rotational movement of each display segment around its longitudinal axis.

Mounting the display segments is accomplished by attaching the ends of the display segments to one or two conventional mounts 101 attached to a surface (not shown) in such a way that the display segments are able to rotate freely on their longitudinal axis with respect to the mounting surface. The mounted display segments are proximally located to each other. Each display segment has sufficient length to define areas on its exterior as a receiver substrate for picture sections to be displayed.

Altering the center of mass of each display segment is illustrated in FIG. 3, which illustrates modifying the center of mass of a display segment by adding an internal mass 120, which may be made of a ferrous metal, lead, plastic, polymer, or other type of material suitable for use as an internal weight.

Defining areas on the exterior of the display segments for use as receiver substrate areas to be used for picture sections to be displayed begins by examining an end of a mostly horizontal, freely rotating display segment. Its center of mass will be lower than its axis of rotation, at a location closer to earth due to the force of gravity. A plane defined by the intersection of the point defining its center of mass and a line defining its axis of rotation will intersect with the exterior cylindrical surface of the display segment along two lines on the exterior of the cylinder, dividing the display segment into two halves. There will be a right side half and a left side half when looking at the end of a display segment, the left side half and right side half defining two receiver substrate areas. When all display segments are generally parallel, generally horizontal, and freely rotating, all right sides will be defined to be to the right of its axis of rotation. All left sides will be defined to be on the left of its axis of rotation. It is important to note that the right side and left side of a display segment will switch if the display segment is flipped end-for-end. It is therefore important to keep right sides and left sides from changing throughout the build of the display system process by maintaining all display segments in similar, parallel orientations to avoid any end-to-end flipping of display segments.

Selecting pictures follows, followed by cutting the selected pictures into smaller picture sections calculated to fit within the physical dimensions of the right side half and left side half receiver substrate areas defined above.

Attaching the smaller picture sections in a coordinated sequential manner to successive receiver substrate locations on sequential and proximally located display segments is accomplished using an appropriate attachment means, using adhesive, tape, or similar substance or means to attach the picture sections to the receiver substrate locations. In a most preferred embodiment, the picture sections are printed onto the surface of curved, removable display sleds with semicircular cross sections extending the length of the display segments and slidably attached to one or more tongues 320 as illustrated in FIG. 11 through a corresponding lengthwise groove in the sled, or slidably attached to grooves 330 as illustrated in FIG. 12 through corresponding tabs or tongue along its lengthwise edges. FIGS. 5A, 5B, 6A, and 6B shows steps in the cutting of two pictures into picture sections. FIGS. 7A through 7D illustrate combining the picture sections from FIGS. 6A and 6B into multiple single sheet units.

Whereas the picture sections from FIG. 6B are used in FIGS. 7A through 7D, the picture sections from FIGS. 5A and 5B are used in FIG. 9, showing the relationship of the different picture sections with respect to each other when attached to a display system of the current invention. Typically, one side of the force-orienting display system will display a picture to the viewer with its picture sections stacked in a sequentially correct order to display a picture, as the “1” picture in FIG. 9 shows. The side facing away from the viewer will be displaying a stacking order in a reverse, inverted order. The hidden dashed lines of the “2” picture in FIG. 9 illustrate this reversed stacking order.

### OPERATION

### Preferred Embodiment

In its preferred embodiment, the process of operating a force-orienting display system as illustrated in FIG. 1 involves mounting the display system on the outside surface of a drum which can rotate along its longitudinal axis, such as on the exterior of a concrete mixer drum. One or more display segments 100 are positioned generally parallel to the drum's longitudinal axis and sufficiently close to each other to allow free rotation around the drum. As the drum rotates through 360°, the force-orienting display system will align all of its display segments in a similar orientation to a viewer with respect to the surface of the drum, displaying one picture right-side up on one side of the drum, and displaying a second image right-side up on the opposite side of the drum.

### DESCRIPTION

### Alternate Embodiments

Referring again to FIG. 1, an alternate embodiment of a display system of the present invention is shown by providing one or more display segments 100, mounting one or more display segments on an essentially flat, generally vertical, rotating or movable surface, such as a display in a store, selecting, cutting and attaching picture sections to receiver substrate locations, and displaying its pictures sections to display a picture. The positioning of the display segments will be generally horizontal.

As the rotating, generally vertical surface is rotated 180°, the picture displayed will change from displaying the picture on its right side to displaying the picture on its left side. As the rotating, generally vertical surface is rotated through another 180°, the picture displayed will alternate from displaying the picture on its left side to displaying the picture on its right side. The picture displaying cycle then repeats.

Yet another alternate embodiments has a procedure for mounting the system on non-flat surfaces.

Still another alternate embodiment incorporates the application of one or more known different forces to act on the display segments, such as magnetism, acting on an internal, ferrous mass, which is used simultaneously as a mass to alter its overall center of mass.

There is an alternate embodiment in defining the number of receiver substrate areas, defining four receiver substrate locations around the display segments instead of two. Gravity and magnetism could then be used in conjunction to display one of four images.

An alternate embodiment for altering the center of mass of the display segments is noted by designing a portion of the display segment to comprise materials of differing densities, thus making one portion of the display segment heavier or lighter. Alternately, hollow display segments can be extruded to have differing wall thicknesses around its circumference yet consistent along its length, giving that portion of the display segment with its thicker walls more mass.

Locating the rotational mechanism 110 has alternate embodiments, as the rotational mechanism may be integral to the display segment, or it may be integral to its mount.

An alternate embodiment for designing the display segments' configuration provides display segments which contain smaller diameter display segments, or may contain smaller diameter cylinders.

Another embodiment uses transparent tubing which is slid over the display segments and picture sections to attach, secure, and retain the picture sections to the display segments.

Yet another additional embodiment for providing conventional mounts can be established in using mounts which conduct electricity or incorporate electrical conductors for conducting electricity for light generating elements 310, such as a light emitting diode, or powering any subsequent internal devices.

Another embodiment for attachment of picture sections is that they can be removably secured to by any appropriate attachment expedient, such as magnetic backed picture sections and a magnetically attractive surface, by the use of Velcro interconnective material on the backs of the picture sections and on the receiver substrate areas.

An alternate embodiment for attaching the graphic sections is evident in that some picture sections will bear a convenient adhesive layer on their obverse, protected by a strippable liner, where the liner can be pulled away from the picture section, exposing an adhesive surface.

Yet another alternate embodiment is for pictures which are painted or printed onto the receiver substrate areas.

### OPERATION

### Alternate Embodiments

Referring again to FIG. 1, in an alternate embodiment of a display system of the present invention, initial operation starts by providing and mounting the display segments on an essentially flat, generally vertical, rotating or movable surface (not shown), then selecting, cutting and attaching picture sections to receiver substrate areas on the display segments. By moving or rotating the movable surface, one or two pictures are alternately displayed. The properly displayed, forward facing picture surface could be part of a point-of-purchase display, with alternating messages or images displayed to shoppers.

### CONCLUSION, RAMIFICATION, AND SCOPE

The result of the present invention is a system for displaying one or more pictures mounted on one or more independent, freely rotatable display segments which are attached close to each other on a movable surface. The movable surface acts to change the position and orientations of the different display segments with respect to the surface and to nearby display segments, causing a coordinated change of display between one of two different pictures.

A mounting surface need not be completely flat, but the display segments are always required to rotate freely with respect to the mounting surface, taking into account all possible movements of the mounting surface. Each display segment attached to a rotating surface must be verified to have free, unobstructed rotation throughout the entire range of motion of the surface.

The display segments must remain generally parallel to each other. They will properly align to display pictures while their axes of rotation are synchronized left sides to left sides, and in a primarily non-vertical orientation. They are not required to be confined to horizontal orientations only, as gravity continues to act on the horizontal component of the center of mass acting on the center of rotation of the display segment to provide a rotational moment when the display segment is not in a true horizontal orientation. However, as the axes of rotation of the display segments approach a vertical orientation, the centers of mass of the display segments become more closely aligned with the axes of rotation, the rotational moment of the horizontal component of gravity on the center of mass acting along the center of rotation approaches zero, and gravity begins to have less effect in providing its novel, desired alignment force on the display segments, and the display coordination breaks down.

While the above description contains many specifications, these should not be construed as limitations on the scope of the invention, but as exemplifications of the presently preferred embodiments thereof. Many other ramifications and variations are possible within the teachings of the invention.

Thus the scope of the invention should be determined by the appended claims and their legal equivalents, and not by the examples given.

I claim:

1. A display system and a process for making a force-aligning display system comprising the steps of:
(a) providing one or more elongated display segments;
(b) identifying and ensuring a center of mass of said display segment is at a location other than collinear to an axis of rotation of said display segment;
(c) providing one or more mounts to which to attach said display segment to a surface;
(d) providing a rotational device proximally to said display segment and said mount;
(e) positioning said display segments proximally to each other allowing unobstructed and independent rotation around said axis of rotation of each display segment with respect to said surface;
(f) identifying receiver substrate areas on an exterior of said display segments;
(g) providing one or more pictures to be displayed on said receiver substrate area of said display segments;
(h) cutting said pictures into picture section sizes determined by said receiver substrate area of said display segment; and
(i) attaching said picture section to said receiver substrate area; whereby a force acting on said center of mass of said display elements rotates said display elements to a known orientation in relation to each proximally located display segment, disposing receiver substrates toward a viewer with respect to said attachment surface, and provides synchronized and coordinated orientation of said picture sections mounted on said receiver substrates disposed toward said viewer to display one or more pictures.

2. The process of claim 1 wherein a cross section of said display segments are circular.

3. The process of claim 1 wherein a cross section of said display segments are non-circular.

4. The process of claim 1 wherein said display segments are hollow.

5. The process of claim 1 wherein said display segments are solid.

6. The process of claim 1 wherein said center of mass is altered by addition of an internal weight.

7. The process of claim 6 wherein said internal weight comprises a ferrous metal.

8. The process of claim 4 wherein said display segments are light transmissible.

9. The process of claim 4 wherein said display segments are illuminated internally.

10. The process of claim 1 wherein said center of mass is intentionally determined in the design process, using materials with different densities around a circumference and applied lengthwise along said display segments during their construction.

11. The process of claim 1 wherein said center of mass location is designed into said display element by incorporating a cross section with walls of different thicknesses around a circumference and applied lengthwise along said display segment.

12. The process of claim 1 wherein said rotational mechanism is integral to said display segment.

13. The process of claim 1 wherein said rotational mechanism is integral to said mount.

14. The process of claim 1 wherein curved, removable attachment sleds are slidably attached to said display segment via a tongue and groove system.

15. The process of claim 1 wherein curved, removable attachment sleds are clipped into place by means of slots on said display segment and tabs on lengthwise edges of said curved attachment sleds.

16. The process of claim 1 wherein removable, transparent retaining tubes are slidably attached around said display segments and said picture sections as a mounting mechanism.

17. The process of claim 1 wherein said display elements are of substantially equal length, with sufficient surface area on its exterior to define receiver substrate areas on said exterior whose said receiver substrate areas are used to mount picture sections.

18. The process of claim 1 wherein said display elements are of substantially different length, with sufficient surface area on its exterior to define receiver substrate areas on said exterior whose said receiver substrate areas are used to mount picture sections.

19. The process of claim 1 wherein an axis of rotation of said display segment intersects with said center of mass of said display segment.

20. The process of claim 1 wherein an axis of rotation of said display segment is in a location that does not intersect with said center of mass of said display segment.
